(19) United States
(12) Patent Application Publication
(10) Pub. No.: US 2026/0348823 A1
(43) Pub. Date: Nov. 5, 2026

(54) Measuring Gas Permeability of Samples with Curved Surfaces

(71) Applicant: Saudi Arabian Oil Company, Dhahran (SA)

(72) Inventors: Nayef M. Alanazi, Dammam (SA); Ali Hayek, Dhahran (SA); Maryam S. Ramadhan, Dammam (SA); Reem A. Alalwan, Dammam (SA)

(21) Appl. No.: 19/195,890

(22) Filed: May 1, 2025

(51) Int. Cl. G01N 15/08

(52) U.S. Cl. CPC G01N 15/0826; G01N 15/0806

(57) ABSTRACT

To measure gas permeability of samples with curved surfaces, a system includes a pipe cell that defines a curved interior volume that complements the curvature of the curved pipe sample, allowing for the measuring of the gas permeability of the pipe sample without flattening or applying stress on the pipe sample. The gas permeability of the curved pipe sample is determined through the injection of a sample gas against the curved pipe sample within the pipe cell. As the gas permeates across the curved pipe sample, a computer system receives pressure measurement from multiple sensors connected to the system corresponding to the pressure of the sample gas. The computer system uses the pressure measurement as input and calculates the gas permeability of the curved pipe sample. The outcome of the calculated gas permeability of the curved pipe sample is displayed to the user of the system.

### TECHNICAL FIELD

This disclosure relates to measuring the gas permeability of samples, specifically, solid samples having curved surfaces.

### BACKGROUND

Gas permeability is the phenomenon of a gas molecule's ability to pass through and permeate through a solid barrier. Gas permeability is relevant in a variety of applications such as food packaging and pipelines for determining the rate at which gas particles may permeate through their solid enclosures. The gas permeability of a material can be measured using a variety of methods. One method to measure the gas permeability of a solid material is to flow gas onto one surface of the material and measure any gas flowing from an opposite surface of the material.

### SUMMARY

This disclosure describes technologies relating to measuring the gas permeability of a sample exhibiting curved surfaces.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 illustrates an example of the system for measuring a gas permeation rate of a curved sample.

FIG. 2 illustrates an exploded view of an example pipe cell with a curved sample.

FIG. 3A illustrates an example insert member as viewed from the side.

FIG. 3B illustrates an example insert member as viewed from below.

FIGS. 4A-4C illustrate different example configurations of insert members.

FIG. 5 is a flowchart of an example of a process of measuring gas permeability of samples with curved surfaces.

Like reference numbers and designations in the various drawings indicate like elements.

### DETAILED DESCRIPTION

This disclosure relates to measuring the gas permeability of a sample exhibiting curved surfaces. Some methods for measuring gas permeability involve placing the sample in a sample holder and sealing opposing surfaces of the sample holder. Often, the sample holder has flat surfaces. Unless a sample is already flat, i.e., free of curvature, the sample is flattened, Flattening removes any curvatures in the sample when the sample is sealed within the sample holder. If a sample with natural curvature is placed and sealed within such a sample holder, then the sample may be flattened to remove the curvature. Flattening the sample can apply stresses on the sample material. Specifically, the material on some layers of the sample may be pushed towards each other while material on other layers of the sample may be pushed away from each other. Such stresses can cause the formation of microcracks (or microfractures) on the sample. Such microcracks, although present, may not be visible to the naked eye. When a flattened sample with stress-induced microcracks is tested for gas permeability using the method described earlier, the flow path formed by the microcracks can result in incorrect gas permeability measurements of the sample itself. Specifically, the microcracks can result in errors in the gas permeability measurements.

Pipes, e.g., hollow, elongate tubulars through which fluids flow, are examples of samples for which gas permeability can be measured by the technique described earlier. Due to the circular cross-section of a pipe, however, a pipe sample or a portion of a pipe sample can have a curved surface. Since pipes come in a variety of materials, thicknesses, and diameters, some pipe samples can retain curved surfaces, which can impact the accuracy of measurements of certain gas permeability measurement methods.

This disclosure describes a gas permeability measurement system that accommodates curved samples, i.e., samples with curvatures. Specifically, the system described here can test the gas permeability of a curved sample. Implementing the system and techniques described in this disclosure allows for a reliable approach to measuring the permeability of a sample regardless of its relative geometry or curvature. As described below, the system enables the sample to be tested without flattening and instead measures gas permeability through the curved sample while the sample is in its unstressed state with natural curvature.

In some implementation, the gas permeability measurement system includes a pipe cell (a receptacle to receive the pipe sample) with a curved seat having a curvature that matches the curvature of the surface of the pipe sample. The pipe cell defines a curved interior volume within which the pipe sample is sealed without stresses that would alter the natural curvature (shape) of the pipe sample. The pipe sample with its natural curvature is positioned within the pipe cell. A gas line is attached to the pipe cell to introduce a sample gas onto the surface of the pipe sample. Another gas line is attached to the pipe cell connected to the opposite surface of the pipe sample allows gas to permeate through the pipe cell and curved sample. Gases that permeates through the sample are collected in a permeate collection tube. The permeate gas that accumulates in the permeate collection tube is then analyzed to measure the gas permeability of the curved sample. The gas permeability is measured by a controller that uses the characteristics of the system and permeate gas as input for a gas permeability calculation.

Implementations of the subject matter described in this disclosure can provide one or more of the following advantages. The implementation allows for a more reliable process for measuring the gas permeability of a sample by reducing the impact of the sample's surface geometry on the measurement results. Due to the curved interior of the pipe cell within which the pipe sample is to be placed, pipe samples no longer need to be flat in shape or flattened to measure their gas permeability. Because the sample need not be flattened, microcracks are not induced in the sample when positioning the sample in the pipe cell. Consequently, the reliability of gas permeability measurements is improved. Eliminating the flattening step provides an additional benefit as samples can be measured for their gas permeability immediately after being cut from a larger pipe piece. This removes the need of a replacement sample in case a microcrack or a microfracture is discovered from a flattening process, leading to quicker measurement of gas permeability and lowering the likelihood of needlessly repetitive testing.

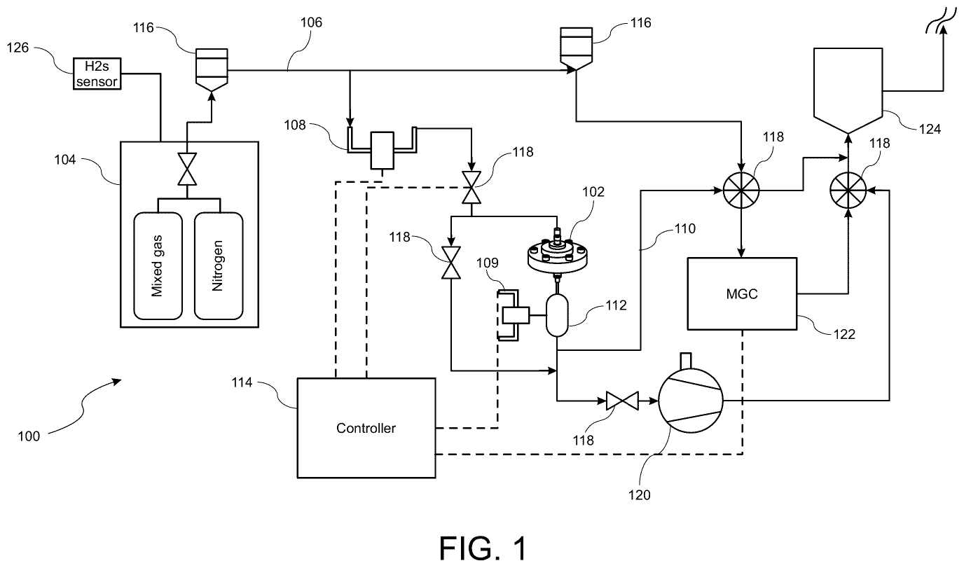

FIG. 1 illustrates an example of a gas permeability measurement system 100 for measuring a gas permeation rate of a curved sample. A sample gas source 104 (e.g., a gas reservoir and a pump to drive the gas in the reservoir) is configured to inject a sample gas into the system 100. A gas feed line 106 (e.g., a pipe or tube) is connected to the sample gas source 104. The gas feed line 106 is configured to allow the sample gas to flow from the sample gas source 104 to other components of the system 100. A first pressure regulator 116 (e.g., pressure-controlled valve) is connected to the gas feed line 106. The first pressure regulator 116 is configured to maintain the sample gas at a pressure which is selected and adjustable by a user. A first pressure sensor 108 is connected to the gas feed line 106. The first pressure sensor 108 is configured to attach to the pipe structure. The first pressure sensor 108 is configured to measure the pressure of a gas within the pipe structure and to generate an electrical signal correlating to the measured pressure. A pipe cell 102, the functions of which are detailed below with reference to the following figures, is connected to the gas feed line 106. A hydrogen sulfide (H₂S) sensor 126 configured to detect the presence of H₂S gas molecules within the system 100 by generating an electrical signal correlating to the measured concentration of H₂S molecules within the system 100.

A permeate line 110 (e.g., a pipe or tube) is connected to the pipe cell 102 at the end opposite of the gas feed line 106 to allow permeate gas to permeate from the pipe cell 102 to other components of the system 100. A permeate collection tube 112 (e.g. a container defining a shallow volume) is connected to the permeate line to capture permeate gas molecules which have permeated through the cell pipe 102 and pipe sample. A second pressure sensor 109 is connected to the permeate collection tube 112. The second pressure sensor 109 is configured to measure the pressure of the permeate gas molecules within the permeate collection tube 112. A micro gas chromatograph (MGC) sensor 122 is connected to the permeate line 110 and is configured to analyze the composition of the gases in the system and generate an electrical signal corresponding to the makeup of the analyzed gases. A vacuum pump 120 is connected to the permeate line 110. The vacuum pump 120 is configured to remove gas traces by pumping the gas traces from the permeate line 110 to a scrubbing unit 124. The scrubbing unit 124 is a filtration instrument configured to neutralize chemicals (e.g., H₂S gas molecules) in a mixture prior to the venting of the permeate gas into the atmosphere. In some implementations, at least one manual valve 118 is connected to the gas feed line 106 or the permeate line 110 and is configured to allow for the manual opening and closing of piping within the system 100.

As shown in FIG. 1, the system includes a controller 114. The controller 104 can be a computer system including one or more processors and a computer-readable storage medium (e.g., a non-transitory computer-readable storage medium). The computer-readable storage medium is configured to store computer instructions. The one or more processors are configured to execute the computer instructions to perform the operations described here. The controller 114 is connected electronically to the multiple sensors in the system 100 and is configured to receive electrical signals from the sensors. The electrical signals received by the controller 114 correspond to the pressure of the sample gas in the system 100 as measured by the first pressure sensor 108 and second pressure sensor 109, the makeup of the analyzed gases as measured by the MGC sensor 122, and the concentration of H₂S molecules present in the system 100 as measured by the H₂S sensor 126 respectively. The controller 114 determines the gas permeability of a curved sample within the pipe cell 102 by calculating gas permeability by executing Equation 1 (below). When executing Equation 1, the controller 114 uses the electrical signals received from the sensors in the system 100 as inputs. The controller 114 is further configured to transmit the output of the calculation to one or more user interfaces such as a monitor or a local display (not shown). Redundant sensors can be utilized within the system. That is, two sensors that measure the same target parameter can be implemented so that one of the sensors of one type can measure the target parameter in case the other sensor of the same type fails. In particular, the multiple sensors can include the first pressure sensors 108, the second pressure sensor 109, multiple MGC sensors 122, and/or multiple H₂S sensors 126.

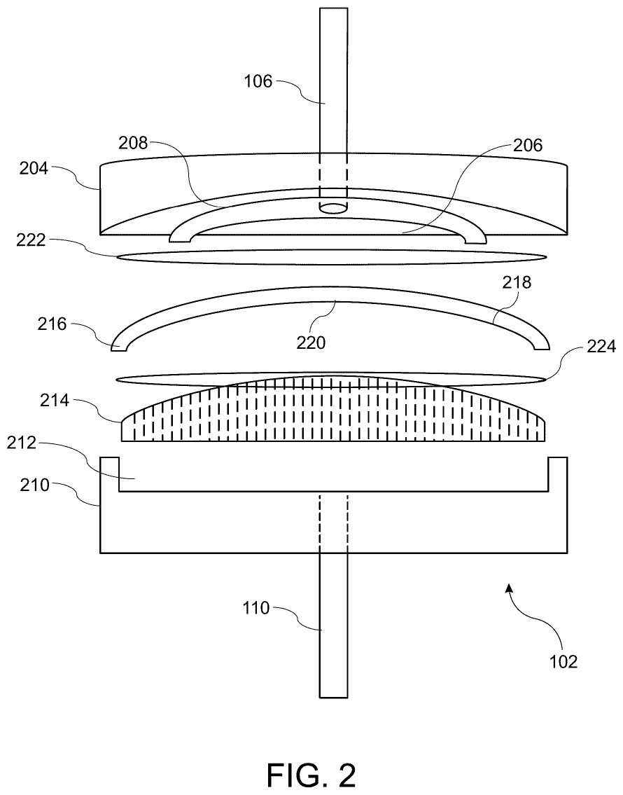

FIG. 2 illustrates an exploded view of an example pipe cell 102 surrounding a curved sample 216. The pipe cell 102 includes a first cell portion 204, which can include a plate member. The first cell portion 204 either includes or defines a curved member 208. The first cell portion 204 also defines a first recess 206. The pipe cell 102 includes a second cell portion 210 (also a plate member) defining a second recess 212. The first cell portion 204 and the second cell portion 210 are configured with complementary surfaces to allow them to secure the curved sample 216 inserted within. An insert member 214 is configured for insertion in the second recess 212 within the second cell portion 210. A first O-ring 222 is used to form a seal within the pipe cell 102 above the curved sample 216. A second O-ring 224 is used to form a seal within the pipe cell 102 below the curved sample 216.

The pipe cell 102 defines an internal volume with a curved geometry that matches the curved geometry of the curved sample 216 when the curved sample 216 is inserted in the pipe cell 102. The upstream surface of the first cell portion 204 defines a first opening configured to connect to the gas feed line 106 and to permit sample gas to flow into the pipe cell 102. The sample gas flows into the pipe cell 102 upstream of the first cell portion 204 from the gas feed line 106 through the first opening. The first cell portion 204 defines the curved member 208 in the downstream surface of the first cell portion 204. The curved member 208 defines a second opening for the sample gas to flow into the internal volume of the pipe cell 102. The volume of the first recess 206 as defined by the first cell portion 204 curves inwards towards first cell portion 204 forming an n-shaped curve against the downstream surface of the curved member 208. The curved geometry of the volume defined by the first recess 206 matches the geometry of the first surface of the curved sample 218 (i.e. the curvature of the top surface of the curved sample 218 matches the curvature of the first recess 206 defined by the curved member 208 to enable a full seal around the curved sample 216.) The first recess 206 matches the curvature of the curved sample 216 without introducing stresses that could alter the natural curvature or permeability of the curved sample 216. This is accomplished by selecting a first cell portion 204 with a curved member 208 defining a first recess 206 with a complementary curvature to that of the curved sample 216.

The second cell portion 210 is positioned downstream of the first cell portion 204. The upstream face of the second cell portion 210 defines a second recess 212 which faces the downstream face of the first cell portion 204. The second recess 212 is cylindrical in shape with a flat base configured for housing an insert member 214 without creating a gap between the insert member and the side walls of the second recess 212. In some implementations, an O-ring may be positioned around the circumference of the insert member 214 to seal any gaps between an outer surface of the insert member 214 and an inner surface of the second cell portion 210 that defines the second recess 212. In some implementations, the second recess 212 may have a non-circular shape (e.g., the shape of a quadrilateral). In such implementations, the insert member 214 is made of a shape that complements the second recess 212 as to allow the insert member 214 to fill the second recess 212 volume with minimal air gaps.

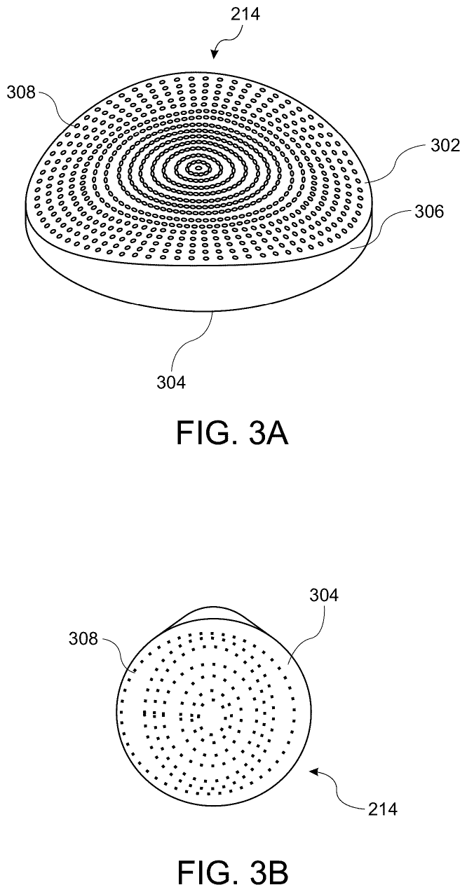

As detailed below with reference to FIG. 3, the insert member 214 is formed with an upstream curved surface 302. The curvature of the curved surface 302 matches the curved geometry of the second surface of the curved sample 202 to minimize air gaps surrounding the curved sample 216 without introducing stresses that could alter the natural curvature or permeability of the curved sample 216. The second cell portion 210 is configured to connect to the permeate line 110 to the downstream surface of the second cell portion 210. The second recess 212 defines an opening to allow gas molecules that have permeated through the curved sample 216 and the insert member 214 to further travel through the second cell portion 210 and into the permeate line 110.

Returning to FIG. 2, the curved sample 216 is positioned between two O-rings. The first O-ring 222 is positioned between the first cell portion 204 and the curved sample 216. The first O-ring 222 forms the seal around the curved sample 216 to prevent gas molecules from leaking into the permeate line without permeating through the curved sample 216. A second O-ring 224 is positioned between the curved member 214 and the curved sample 216. The second O-ring 224 forms the seal around the curved sample 216 to prevent gas molecules from leaking into the permeate line without permeating through the curved sample 216. The first O-ring 222 and the second O-ring 224 are made from elastic material sufficient to assume the curved shape of the internal volume of the pipe cell 102 while also sufficiently sealing the curved sample 216 to prevent any leaking of the gas molecules.

FIGS. 3A and 3B illustrate an example of the insert member 214 as viewed from different perspectives. FIG. 3A illustrates the insert member 214 as viewed from the side. The insert member 214 includes a cylindrical disk-shaped portion that has a circular cross-section of uniform height, and another non-cylindrical portion positioned upstream of the cylindrical portion to define the curvature. The combined heights of the cylindrical and non-cylindrical portions define an insert member side wall 306 that is solid and non-porous. The height of the insert member 214 is configured to allow the pipe cell 102 to close both portions while allowing the insert member 214 and the curved sample 216 to occupy the volume defined by the pipe cell 102 when closed.

As shown by FIG. 3A, the curvature of the non-cylindrical portion is defined by a curved surface 302 of the insert member 214. The curved surface 302 is the upstream surface configured to contact the curved sample 216 within the pipe cell 102. The curvature of the curved sample 216 closely matches the curvature of the curved surface 302 to minimize air gaps between the curved insert member 214 and the curved sample 216 when the curved sample 216 is inserted into pipe cell 102. A second surface 304 of the insert member 214 is the downstream surface opposite of the curved surface 302. The second surface 304 has a flat circular shape to complement the shape of the second recess 212 within the second cell portion 210. In some implementations, the second surface 304 is shaped to match the second recess 212 to allow the insert member 214 to be inserted into the second recess 212 without significant air gaps.

The curved surface 302 and the second surface 304 of the insert member 214 are defined by a porous mesh 308. The porous mesh 308 is made of multiple openings that are uniformly distributed across the surfaces of the insert member 214. In some implementations, the openings of the porous mesh 308 may exhibited a non-uniform pattern. Each opening of the porous mesh 308 defines a hallow volume extending throughout the height of the insert member 214. The porous mesh 308 is configured to allow gas molecules that have permeated through the curved sample 216 to further permeate through the insert member 214 downstream towards the permeate collection tube 112, while still maintaining the structural integrity of the insert member 214. The diameter of each opening of the porous mesh 308 matches the diameter of other openings of the porous mesh 308. In some implementations, the radius of the openings of the porous mesh 308 can vary based on variables such as the composition of the sample gas molecules, the relative position of the opening within the porous mesh 308, the curvature of the curved surface 302 of the insert member 214, the pressure of the sample gas used, and the number of openings present in the porous mesh 308 of the insert member 214.

FIG. 3B illustrates the insert member 214 as viewed from below. The second surface 304 of the insert member 214 defines as circular and flat in shape with the downstream openings of porous mesh 308 visible. In some implementations, the second surface 304 of the insert member 214 may assume a different shape to allow the insert member 214 to be inserted into the second recess 212 without significant air gaps.

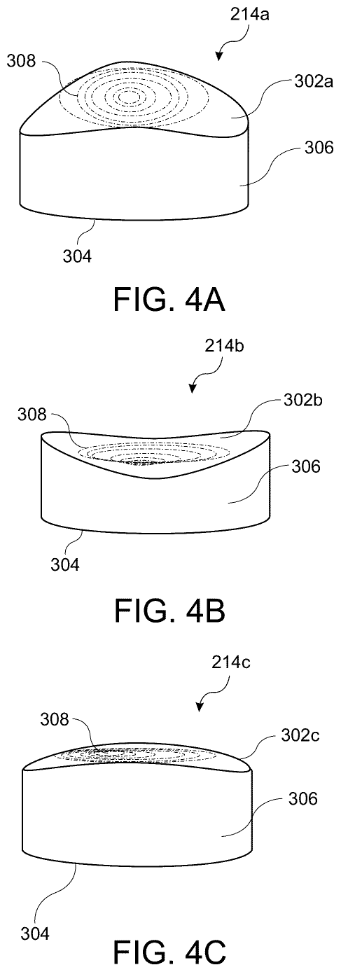

FIGS. 4A-4C illustrate different example configurations of the insert member 214a-214c with respective, varying curvatures for each respective curved surface 302a-302c. FIG. 4A shows an example of an insert member 214a with a curved surface 302a exhibiting a downward curve pointed downstream relative to the insert member 214a to resemble an n-shaped curve. FIG. 4B shows an example of an insert member 214b with a curved surface 302b exhibiting an upward curve pointed upstream relative to the insert member 214b to resemble a u-shaped curve. FIG. 3C shows an example of an insert member 214c similar to that of FIG. 4A with a curved surface 302c exhibiting a downward curve pointed downstream relative to the insert member 214c. Unlike FIG. 4A's curved surface 302a, the curved surface 302c of FIG. 4C exhibits a more gradual and less severe curve. Other embodiment of the insert member 214 with varying degrees of curved surfaces 302 not shown in the figures can be used based on the curvature and geometry of the curved sample 216 being tested.

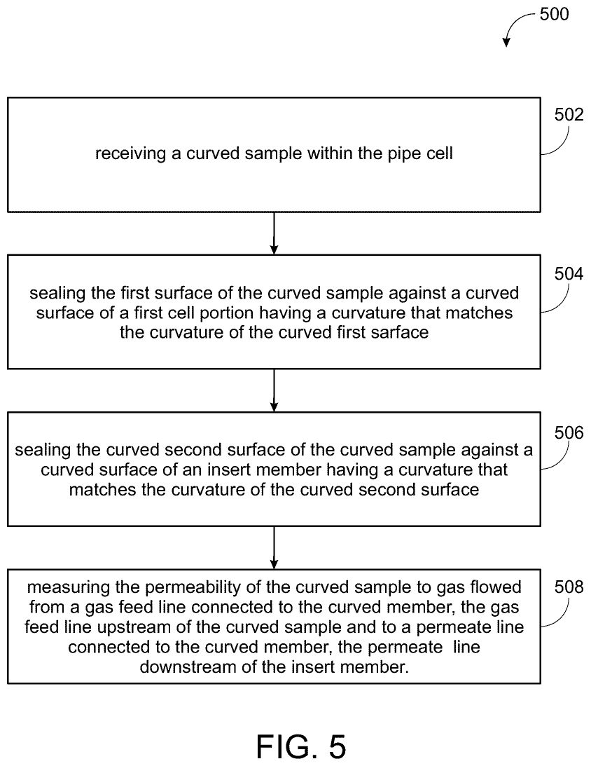

FIG. 5 is a flowchart of an example of a process of measuring gas permeability of samples with curved surfaces. As shown in FIG. 5, step 502 the pipe cell 102 receives a curved sample 216 within the volume defined within the pipe cell 102. In steps 504 and 506, the curvature of the curved sample 216 is matched on both sides. That is, under step 504, the curvature of first surface of the curved sample 218 matches the curvature of the curved member 208 of the first cell portion 204. The first O-ring 222 is placed above the curved sample 216 and below the curved member 208 to provide a stronger seal around the upper surface of the curved sample 216. Similarly, under step 506, the curvature of second surface of the curved sample 220 matches the curvature of an appropriately chosen insert member 214 when placed within the second recess 212 of the second cell portion 210. The second O-ring 224 is placed below the curved sample 216 and above the insert member 214 to provide a stronger seal around the lower surface of the curved sample 216.

In step 506, the gas permeability of the curved sample 216 is measured. This step involves the use of a system similar to the one described in FIG. 1 above. After the inserting and sealing the curved sample 216 within the pipe cell 102, sample gas is injected into the system from the sample gas source 104 to flow through the gas feed line 106 into the pipe cell 102. The sample gas flowing through the system is injected at a predetermined pressure that is measured by the first pressure sensor 108. The pressure measurement from the first pressure sensor 108 is transmitted to the controller 114 to be used as input for a gas permeation calculation. The sample gas molecules injected into the pipe cell 102 permeate through the curved sample 216 and the curved member 214. After permeating through the pipe cell 102, the sample gas molecules accumulate inside the permeate collection tube 112, where the pressure within the tube is measured by the second pressure sensor 109. The pressure reading of the sample gas molecules within the permeate collection tube 112 is transmitted to the controller 114. The sample gas molecules further flow into the MGC 122 to analyze the composition of the sample gas molecules within the permeate collection tube 112 and to determine the respective permeability of the sample gases used.

The controller 114 determines gas permeability of the curved sample 216 in step 506 by executing the equation:

$$P = 1 {0}^{10} \frac{{V}_{d} l}{{P}_{f} ART} [ {( \frac{{dp}_{p}}{dt} )}_{ss} - {( \frac{{dp}_{p}}{dt} )}_{leak} ] \qquad ( Eq . 1 )$$

where V_{d} is the volume of the permeate collection tube 112 measured in cubic centimeter (cm³), l is the curved sample 216 thickness measured in centimeters (cm), p_{f} is the gas feed pressure measured in centimeters of mercury (cmHg), A is the effective surface area of the curved sample 216 measured in centimeter squared (cm²), R is the universal gas constant (R=0.278 cm³·cmHg·cm⁻³(STP)·K⁻¹), T is the operational temperature measured in Kelvin

$$( {( \frac{{dp}_{p}}{dt} )}_{ss}$$

is the steady-state (ss) pressure variation in the permeate side measured in centimeters of mercury (cmHg), and

$${( \frac{{dp}_{p}}{dt} )}_{leak}$$

is the leak rate of the system. Ine selectivity of a gas pair A and B (a_{A/B}), permeating through the nonmetallic pipe sample, is determined through the ratio of their permeability coefficients (P_{A} and P_{B}) using the following equation:

$${α}_{A / B} = \frac{{P}_{A}}{{P}_{B}}$$

### EXAMPLES

Certain aspects of the subject matter described here can be implemented as a gas permeation rate measurement system. The system includes a pipe cell configured to receive a curved sample for gas permeation shape measurement. The curved sample includes a curved first surface and a curved second surface opposite the curved first surface. The curved first surface and the curved second surface have a curvature. The pipe cell includes a first cell portion and a second cell portion. The first cell portion includes a first plate defining a first recess. A curved member is positioned in the first recess. The curved member has a curved surface configured to contact and seal the curved first surface of the curved sample when the curved sample is received in the pipe cell. The curved member has a curvature that matches the curvature of the curved first surface and the curved second surface. The second cell portion has a second plate defining a second recess. An insert member is configured to be positioned in the second recess. The insert member has a curved surface configured to contact and seal the curved second surface of the curved sample when the curved sample is received in the pipe cell. The curved surface of the insert member has a curvature that matches the curvature of the curved second surface.

An aspect combinable with any other aspect includes the following features. The insert member includes a second surface opposite of the curved surface and a side wall connecting the curved surface and the second surface to define a height of the insert member.

An aspect combinable with any other aspect includes the following features. The second surface is parallel to a portion of the second plate in the second recess.

An aspect combinable with any other aspect includes the following features. The insert member defines multiple openings configured to allow a gas sample to permeate from the curved surface to the second cell portion. Each opening extends from the curved surface to the second surface through the height of the insert member.

An aspect combinable with any other aspect includes the following features. The system includes a container for a gas sample. A gas feed line is connected to the container. A pressure sensor is connected to the gas feed line downstream of the container and upstream of the pipe cell. A permeate line is connected to the second cell portion of the pipe cell. A permeate collection tube defining a volume (Va) is connected to the permeate line downstream of the pipe cell. A computer system is connected to the pressure sensor. The computer system includes one or more processors and a non-transitory computer-readable medium storing computer instructions, which when executed by the one or more processors cause the one or more processors to perform operations. The operations include receiving pressure values representing the gas sample pressure from the pressure sensor, and determining the permeability of a material in the pipe cell by executing Equation 1 above.

An aspect combinable with any other aspect includes the following features. The system includes a first O-ring configured to seal the curved sample.

An aspect combinable with any other aspect includes the following features. The system includes a second O-ring configured to seal the second surface of the insert member.

An aspect combinable with any other aspect includes the following features. The curved member of the first cell portion and the insert member of the second cell portion are configured to contact and seal the curved first surface and the curved second surface, respectively, of the curved sample without causing the curved sample to bend.

Certain aspects of the subject matter described here can be implemented as a method for measuring a permeability of a curved sample. A curved sample including a curved first surface and a curved second surface opposite the curved first surface is received. The curved first surface and the curved second surface have a curvature. The curved first surface of the curved sample is sealed against a curved surface of a curved member having a curvature that matches the curvature of the curved first surface. The curved second surface of the curved sample is sealed against a curved surface of an insert member having a curvature that matches the curvature of the curved second surface. The curved sample is sealed against the curved member and the insert member without causing the curved sample to bend. The permeability of the curved sample to gas flow from a gas feed line connected to the curved member is measured. The gas feed line is upstream of the curved sample and connects to a permeate line connected to the curved member. The permeate line is downstream of the insert member.

An aspect combinable with any other aspect includes the following features. To measure the permeability of the curved sample the gas, the curved sample, which is sealed against the curved member and the insert member, is placed within a pipe cell fluidically connected to the gas feed line and the permeate line. The gas is injected into the pipe cell through the gas feed line.

An aspect combinable with any other aspect includes the following features. To measure the permeability of the curved sample to the gas, a computer receives pressure values representing the gas sample pressure from a pressure sensor connected to the gas feed line. The permeability of the curved sample in the pipe cell is determined using Equation 1 described above.

An aspect combinable with any other aspect includes the following features. A first cell portion is formed by forming a first recess in a first plate and positioning the curved sample in the recess formed in the first place. A second cell portion is formed by forming a second recess in a second plate and positioning the insert member in the recess formed in the second plate.

An aspect combinable with any other aspect includes the following features. The curved first surface of the curved sample is sealed by placing a first O-ring against the curved first surface of the curved sample and the curved surface of the curved member. The curved second surface of the curved sample is sealed by placing a second O-ring against the curved second surface of the curved sample and the curved surface of the insert member.

An aspect combinable with any other aspect includes the following features. To measure a permeability of a curved sample, a second curved sample including a curved first surface and a curved second surface opposite the curved first surface is received. The curved first surface and the curved second surface of the second curved sample is different from the curvature of the first curved sample. The curved first surface of the second curved sample is sealed against a curved surface of the curved member having a curvature that matches the curvature of the curved first surface of the second curved sample. The curved second surface of the second curved sample is sealed against a curved surface of a second insert member having a curvature that matches the curvature of the curved second surface of the second curved sample. The second curved sample is sealed against the curved member and the insert member without causing the curved sample to bend. The permeability of the second curved sample to gas flowed from a gas feed line connected to the curved member is measured. The gas feed line is upstream of the curved sample and is connected to a permeate line connected to the curved member. The permeate line is downstream of the insert member.

Certain aspects of the subject matter described here can be implemented as a gas permeation rate measurement system. The system includes a pipe configured to receive a curved sample for gas permeation shape measurement. The curved sample includes a curved first surface and a curved second surface opposite the curved first surface. The curved first surface and the curved second surface have a curvature. The pipe cell includes a first cell portion, which includes a first plate defining a first recess, and a curved member positioned in the first recess. The curved member has been selected from multiple curved members of unique curvatures due to the curved member having a curved surface that contacts and seals the curved first surface of the curved sample when the curved sample is received in the pipe cell. The curved member has a curvature that complements the curvature of the curved first surface and the curved second surface. The pipe cell includes a second cell portion that includes a second plate defining a second recess, and multiple insert members. Each of the insert members includes a curved surface configured to contact and seal the curved second surface of the curved sample when the curved sample is received in the pipe cell, a second surface opposite of the curved surface, and a side wall connecting the curved surface and the second surface to define a height of the insert member. The curved surface of each insert member is differently curved. At least one of the multiple insert members has a curvature of its curved surface that matches the curvature of the curved second surface of the curved sample.

An aspect combinable with any other aspect includes the following features. The selected curved member and insert members are configured to contact and seal the curved first surface and the curved second surface, respectively, of the curved sample without causing the curved sample to bend.

Several implementations of the subject matter have been described. Other implementations, alterations, and permutations of the described implementations are within the scope of the following claims as will be apparent to those skilled in the art.

1. A gas permeation rate measurement system comprising:
a pipe cell configured to receive a curved sample for gas permeation shape measurement, the curved sample comprising a curved first surface and a curved second surface opposite the curved first surface, the curved first surface and the curved second surface having a curvature, the pipe cell comprising:
a first cell portion comprising:
a first plate defining a first recess, and
a curved member positioned in the first recess, the curved member having a curved surface configured to contact and seal the curved first surface of the curved sample when the curved sample is received in the pipe cell, the curved member having a curvature that matches the curvature of the curved first surface and the curved second surface; and
a second cell portion comprising:
a second plate defining a second recess, and
an insert member configured to be positioned in the second recess, the insert member having a curved surface configured to contact and seal the curved second surface of the curved sample when the curved sample is received in the pipe cell, the curved surface of the insert member having a curvature that matches the curvature of the curved second surface.

2. The system of claim 1, wherein the insert member further comprises:
a second surface opposite of the curved surface, and
a side wall connecting the curved surface and the second surface to define a height of the insert member.

3. The system of claim 2, wherein the second surface is parallel to a portion of the second plate in the second recess.

4. The system of claim 2, wherein the insert member defines a plurality of openings configured to allow a gas sample to permeate from the curved surface to the second cell portion, each opening extending from the curved surface to the second surface through the height of the insert member.

5. The system of claim 1 further comprising:
a container for a gas sample;
a gas feed line connected to the container;
a pressure sensor connected to the gas feed line downstream of the container and upstream of the pipe cell;
a permeate line connected to the second cell portion of the pipe cell;
a permeate collection tube defining a volume (Va) connected to the permeate line downstream of the pipe cell; and
a computer system connected to the pressure sensor, the computer system comprising:
one or more processors; and
a non-transitory computer-readable medium storing computer instructions, which when executed by the one or more processors cause the one or more processors to perform operations comprising:
receiving pressure values representing the gas sample pressure from the pressure sensor; and
determining the permeability of a material in the pipe cell by executing the equation
$$P = 1 {0}^{10} \frac{{V}_{d} l}{{p}_{f} ART} [ {( \frac{{dp}_{p}}{dt} )}_{ss} - {( \frac{{dp}_{p}}{dt} )}_{leak} ]$$
wherein V_{d} is the permeate tube volume, l is the distance between the curved first surface of the curved sample and the second curved surface of the curved sample, p_{f} is the gas sample pressure, A is the surface area of the curved sample, R is the universal gas constant, T is the operational temperature,
$${( \frac{{dp}_{p}}{dt} )}_{leak}$$
is the steady-state pressure variation in the permeate side, and
$${( \frac{{dp}_{p}}{dt} )}_{ss}$$
leak is the leak rate of the system.

6. The system of claim 1, further comprising a first O-ring configured to seal the curved sample.

7. The system of claim 1, further comprising a second O-ring configured to seal the second surface of the insert member.

8. The system of claim 1, wherein the curved member of the first cell portion and the insert member of the second cell portion are configured to contact and seal the curved first surface and the curved second surface, respectively, of the curved sample without causing the curved sample to bend.

9. A method for measuring a permeability of a curved sample, the method comprising:
receiving a curved sample comprising a curved first surface and a curved second surface opposite the curved first surface, the curved first surface and the curved second surface having a curvature;
sealing the curved first surface of the curved sample against a curved surface of a curved member having a curvature that matches the curvature of the curved first surface;
sealing the curved second surface of the curved sample against a curved surface of an insert member having a curvature that matches the curvature of the curved second surface, wherein the curved sample is sealed against the curved member and the insert member without causing the curved sample to bend; and
measuring the permeability of the curved sample to gas flowed from a gas feed line connected to the curved member, the gas feed line upstream of the curved sample and to a permeate line connected to the curved member, the permeate line downstream of the insert member.

10. The method of claim 9, wherein measuring the permeability of the curved sample to the gas comprises:
placing the curved sample sealed against the curved member and the insert member within a pipe cell fluidically connected to the gas feed line and the permeate line; and
injecting the gas into the pipe cell through the gas feed line.

11. The method of claim 9, wherein measuring the permeability of the curved sample to the gas comprises:
receiving, by a computer system and from a pressure sensor connected to the gas feed line, pressure values representing the gas sample pressure; and
determining the permeability of the curved sample in the pipe cell using the equation
$$P = 1 {0}^{10} \frac{{V}_{d} l}{{p}_{f} ART} [ {( \frac{{dp}_{p}}{dt} )}_{ss} - {( \frac{{dp}_{p}}{dt} )}_{leak} ]$$
wherein V_{d} is the permeate tube volume, l is the distance between the curved first surface of the curved sample and the second curved surface of the curved sample, p_{f} is the gas sample pressure, A is the surface area of the curved sample, R is the universal gas constant, T is the operational temperature,
$${( \frac{{dp}_{p}}{dt} )}_{ss}$$
is the steady-state pressure variation in the permeate side, and
$${( \frac{{dp}_{p}}{dt} )}_{leak}$$
leak is the leak rate of the system.

12. The method of claim 9, the method further comprising:
forming a first cell portion by forming a first recess in a first plate and positioning the curved sample in the recess formed in the first plate; and
forming a second cell portion by forming a second recess in a second plate and positioning the insert member in the recess formed in the second plate.

13. The method of claim 9, the method further comprising:
sealing the curved first surface of the curved sample by placing a first O-ring against the curved first surface of the curved sample and the curved surface of the curved member; and
sealing the curved second surface of the curved sample by placing a second O-ring against the curved second surface of the curved sample and the curved surface of the insert member.

14. The method of claim 9, wherein measuring a permeability of a curved sample comprises:
receiving a second curved sample comprising a curved first surface and a curved second surface opposite the curved first surface, the curved first surface and the curved second surface of the second curved sample having a curvature different from the curvature of the first curved sample;
sealing the curved first surface of the second curved sample against a curved surface of a curved member having a curvature that matches the curvature of the curved first surface of the second curved sample;
sealing the curved second surface of the second curved sample against a curved surface of a second insert member having a curvature that matches the curvature of the curved second surface of the second curved sample, wherein the second curved sample is sealed against the curved member and the insert member without causing the curved sample to bend; and
measuring the permeability of the second curved sample to gas flowed from a gas feed line connected to the curved member, the gas feed line upstream of the curved sample and to a permeate line connected to the curved member, the permeate line downstream of the insert member.

15. A gas permeation rate measurement system comprising:
a pipe cell configured to receive a curved sample for gas permeation shape measurement, the curved sample comprising a curved first surface and a curved second surface opposite the curved first surface, the curved first surface and the curved second surface having a curvature, the pipe cell comprising:
a first cell portion comprising:
a first plate defining a first recess, and
a curved member positioned in the first recess, the curved member having been selected from a plurality of curved members of unique curvatures due to the curved member having a curved surface that contacts and seals the curved first surface of the curved sample when the curved sample is received in the pipe cell, the curved member having a curvature that complements the curvature of the curved first surface and the curved second surface; and
a second cell portion comprising:
a second plate defining a second recess, and
a plurality of insert members, wherein each of the insert members comprises:
a curved surface configured to contact and seal the curved second surface of the curved sample when the curved sample is received in the pipe cell,
a second surface opposite of the curved surface, and
a side wall connecting the curved surface and the second surface to define a height of the insert member;
wherein the curved surface of each insert member is differently curved, with at least one of the plurality of insert members having a curvature of its curved surface that matches the curvature of the curved second surface of the curved sample.

16. The system of claim 15, wherein the selected curved member and insert members are configured to contact and seal the curved first surface and the curved second surface, respectively, of the curved sample without causing the curved sample to bend.
